(19) United States
(12) Patent Application Publication
(10) Pub. No.: US 2023/0143086 A1
(43) Pub. Date: May 11, 2023

(54) Catalyst components for the preparation of highly isotactactic polypropylene polymer with broad molecular weight distribution

(71) Applicant: Formosa Plastics Corporation, USA, Livingston, NJ (US)

(72) Inventors: Gapgoung Kong, Sugarland, TX (US); Lei Zhang, Port Lavaca, TX (US); Chih-Jian Chen, Port Lavaca, TX (US); Guangxue Xu, Port Lavaca, TX (US)

(21) Appl. No.: 17/519,846

(22) Filed: Nov. 5, 2021

(51) Int. Cl. C08F 4/6592; C08F 10/06

(52) U.S. Cl. CPC C08F 4/6592; C08F 10/06

(57) ABSTRACT

The present invention relates to a solid catalyst component comprising magnesium, titanium, halide, and internal electron donor compounds comprising dilakylurea, malonate, succinate, and 1,3-diether, wherein the succinate amount is less than about 30% by mol with respect to the total amount of electron donor, the molar ratio between succinate and 1,3-diether is in the range of about 0.1-0.5, and the molar ratio between malonate and 1,3-diether is in the range of about 0.5-2.5. The catalyst component according to present invention provides highly isotactic polypropylene polymer with broad molecular weight distribution.

### BACKGROUND

The present invention relates to Ziegler Natta catalyst components for the preparation of polypropylene polymer having highly isotactic polymer structure with broad molecular weight distribution. While there has been enormous need for polypropylene providing high flexural modulus for high melt flow polypropylene, it has been well known in this area that highly isotactic polypropylene polymer with broad molecular weight distribution can provide high flexural modulus, and there has been significant research and development activities directed to this area.

Recent research has revealed that employing two or more internal electron donors, rather than single electron donor, can fulfill the multiple properties required. For example, U.S. Pat. No. 6,395,670 describes catalyst composition employing two internal donors such as alkyl carboxylic esters and 1,3-diether to have a synergy effect by combining two internal electron donors. U.S. Pat. No. 7,208,435 describes catalyst composition containing multiple electron donor compounds selected from phthalic acid ester or malonates compounds to provide a catalyst component having higher hydrogen response and high stereo-regularity as well.

Succinate compounds have been employed with other electron donors as an internal electron donor component for Ziegler Natta catalysts providing broader molecular weight distribution and isotactic polypropylene structure. For example, U.S. Pat. No. 6,818,583 introduced succinate compounds as at least one internal donors in combination with other electron donors such as 1,3-diethers. U.S. Pat. Nos. 9,068,028 and 9,068,029 described a process for catalyst components employing succinate and 1,3-diether internal donors to prepare crystalline propylene polymers having broad molecular weight distribution, wherein the succinate compound consists of higher than 50% of the total electron donor amount. U.S. Pat. No. 9,593,171 described a catalyst system for impact co-polymers employing succinate and 1,3-diether internal donors, where the 1,3-diether/succinate molar ratio is between 0.8 and 1.8. U.S. Pat. No. 10,221,261 describes a preparation of propylene polymer having Mw/Mn greater than 6.0 with isotacticity greater than 98.0%, in the presence of catalyst comprising Mg, Ti, electron donors of succinate and 1,3-diether wherein the molar ratio of succinate and 1,3-diether is between 4:6-9.1.

Meanwhile, some amide compounds (modifier compounds) have been reported to improve isotacticity of propylene polymer when included within catalyst compositions in combination with many internal donor compounds. For example, U.S. Pat. No. 9,593,184 describes oxalic acid diamide compounds, when included as a catalyst component, improves isotacticity. U.S. Pat. No. 9,815,920 teaches that urea compounds, when included as a catalyst component, also improves isotacticity.

In the present invention, it has been discovered that when succinate compounds are combined with malonate and 1,3-diether in the presence of a urea component (modifier) in the preparation of Ziegler Natta catalyst system, the catalyst prepared thereof can further provide higher isotactic polypropylene polymer with broad molecular weight distribution.

### SUMMARY OF THE INVENTION

It is therefore an object of present invention to provide a solid catalyst component for the polymerization or co-polymerization of alpha-olefins prepared by contacting magnesium and titanium halide components, in the presence of electron donors comprising dilakylurea, malonate, succinate and 1,3-diether compounds, wherein:
(a) succinate amount is less than 30 mol % with respect to total amount of electron donor;
(b) molar ratio between succinate and 1,3-diether (succinate/1,3-diether) is between about 0.1-0.5;
(c) molar ratio between malonate and 1,3-diether (malonate/1,3-diether) is between about 0.5-2.5; and
(d) dialkylurea is selected from compounds represented by Formula (I):

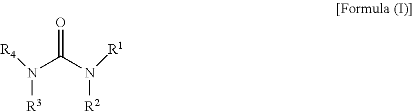

wherein R¹, R², R³, and R⁴ are independently selected from hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a hetero atom containing hydrocarbon group of 1 to 20 carbon atoms, wherein two or more of R¹, R², R³, and R⁴ may be linked to form one or more saturated or unsaturated monocyclic or polycyclic rings.

### DESCRIPTION OF THE INVENTION

In a first embodiment of present invention, a solid catalyst component is obtained by contacting magnesium compound and a titanium halide compound in the presence of electron donors comprising dilakylurea, malonate, succinate and 1,3-diether compounds. Dialkylurea are selected from compounds represented by Formula I:

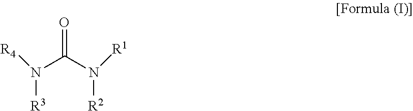

wherein R¹, R², R³, and R⁴ are independently selected from hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a hetero atom containing hydrocarbon group of 1 to 20 carbon atoms, wherein two or more of R¹, R², R³, and R⁴ may be linked to form one or more saturated or unsaturated monocyclic or polycyclic rings.

Examples of dialkylurea include, but are not limited to: N,N,N′N′-tetramethylurea, N,N,N′,N′-tetraethylurea, N,N,N′,N′-tetrapropylurea, N,N,N′,N′-tetrabutylurea, N,N,N′,N′-tetrapentylurea, N,N,N′,N′-tetrahexylurea, N,N,N′,N′-tetra(cyclopropyl)urea, N,N,N′,N′-tetra(cyclohexyl)urea, N,N,N′,N′-tetraphenylurea, bis(butylene)urea, bis(pentylene)urea, N,N′-dimethylethyleneurea, N,N′-dimethylpropyleneurea, N,N′-dimethyl(2-(methylaza)propylene)urea and N,N′-dimethyl(3-(methylaza)pentylene)urea. n-amyltriphenylurea, n-hexyltriphenylurea, n-octyltriphenylurea, n-decyltriphenylurea, n-octadecyltriphenylurea, n-butyltritolylurea, n-butyltrinaphthylurea; n-hexyltrimethylurea, n-hexyltriethylurea, noctyltrimethylurea, dihexyldimethylurea, dihexyldiethylurea, trihexylmethylurea, tetrahexylurea; n-butyltricyclohexylurea, t-butyltriphenylurea; 1,1-bis(p-biphenyl)-3-methyl-3-n-octadecylurea; 1,1-di-n-octadecyl-3-t-butyl-3-phenylurea; 1-p-biphenyl-1-methyl-3-noctadecyl 3 phenylurea; 1-methyl-1-n-octadecyl-3 p-biphenyl-3-o-tolylurea; m-terphenyl-tri-t-butylurea, 1,3-dimethyl-2-imidazolidinone, 1,3-diethyl-2-imidazolidinone, 1,3-dipropyl-2-imidazolidinone, 1,3-dibutyl-2-imidazolidinone, 1,3-dimethyl-3,4,5,6-tetrahydro-2-pyrimidinone, and N,N-dimethyl-N,N,-diphenylurea,

Malonate compounds, for use as internal electron donors in the present invention, are preferably selected from esters of malonic acid, including, but not limited to diethylphenylmalonate, diethyl2-isopropylmalonate, diethyl2-phenylmalonate, dineopentyl 2-isopropylmalonate, diisobutyl 2-isopropylmalonate, di-n-butyl 2-isopropylmalonate, diethyl 2-dodecylmalonate, diethyl 2-t-butylmalonate, diethyl 2-(2-pentyl)malonate, diethyl 2-cyclohexylmalonate, dineopentyl 2-t-butylmalonate, dineopentyl 2-isobutylmalonate, diethyl 2-cyclohexylmethylmalonate, dimethyl 2-cyclohexylmethylmalonate, diethyl 2,2-dibenzylmalonate, diethyl 2-isobutyl-2-cyclohexylmalonate, dimethyl 2-n-butyl-2-isobutylmalonate, diethyl 2-n-butyl-2-isobutylmalonate, diethyl 2-isopropyl-2-n-butylmalonate, diethyl 2-methyl-2-isopropylmalonate, diethyl 2-isopropyl-2-isobutylmalonate, diethyl 2-methyl-2-isobutylmalonate, diethyl 2-isobutyl-2-benzylmalonate, and diethyldiisobutylmalonate.

Succinate compounds, for use as internal electron donors in the present invention, are represented by Formula II below:

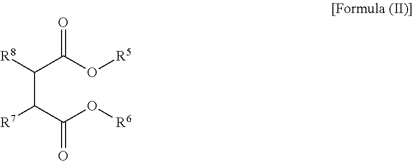

wherein R⁵, R⁶, R⁷, and R⁸ are independently selected from hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a hetero atom containing a hydrocarbon group of 1 to 20 carbon atoms. Preferred examples of succinates include, but are not limited to, diethyl 2,3-diisopropylsuccinate, diethyl 2,3-dibenzylsuccinate, diisobutyl 2,3-diisopropylsuccinate, diethyl 2,3-dicyclopentylsuccinate, and diethyl 2,3-dicylohexylsuccinate.

Preferably, 1,3 di-ether compounds in the solid catalyst component, as described above, are represented by Formula III below:

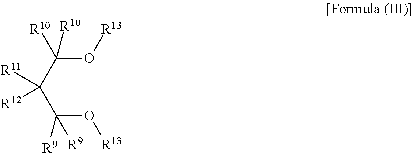

wherein R⁹ R¹⁰, R¹¹, R¹² and R¹³ are independently selected from a hydrocarbon group having 1 to 20 carbon atoms, an aromatic hydrocarbon group having 6-20 carbon atoms, which can form one or more cyclic structure. Preferred examples of 1,3 diethers include, but are limited to: 2-(2-ethylhexyl)1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2-(2-cyclohexylethyl)-1,3-dimethoxypropane, 2-(p-chlorophenyl)-1,3-dimethoxypropane, 2-(diphenylmethyl)-1,3-dimethoxypropane, 2(1-naphthyl)-1,3-dimethoxypropane, 2(p-fluorophenyl)-1,3-dimethoxypropane, 2(1-decahydronaphthyl)-1,3-dimethoxypropane, 2(p-tert-butylphenyl)-1,3-dimethoxypropane, 2,2-dicyclohexyl-1,3-dimethoxypropane, 2,2-diethyl-1,3-dimethoxypropane, 2,2-dipropyl-1,3-dimethoxypropane, 2,2-dibutyl-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2-methyl-2-phenyl-1,3-dimethoxypropane, 2-methyl-2-cyclohexyl-1,3-dimethoxypropane, 2-methyl-2-methylcyclohexyl-1,3-dimethoxypropane, 2,2-bis(p-chlorophenyl)-1,3-dimethoxypropane, 2,2-bis(2-phenylethyl)-1,3-dimethoxypropane, 2,2-bis(2-cyclohexylethyl)-1,3-dimethoxypropane, 2-methyl-2-isobutyl-1,3-dimethoxypropane, 2-methyl-2-(2-ethylhexyl)-1,3-dimethoxypropane, 2,2-bis(2-ethylhexyl)-1,3-dimethoxypropane, 2,2-bis(p-methylphenyl)-1,3-dimethoxypropane, 2-methyl-2-isopropyl-1,3-dimethoxypropane, 2,2-diisobutyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 2-isobutyl-2-isopropyl-1,3-dimetoxypropane, 2,2-di-sec-butyl-1,3-dimetoxypropane, 2,2-di-tert-butyl-1,3-dimethoxypropane, 2,2-dineopentyl-1,3-dimethoxypropane, 2-iso-propyl-2-isopentyl-1,3-dimethoxypropane, 2-phenyl-2-benzyl-1,3-dimetoxypropane, 2-cyclohexyl-2-cyclohexylmethyl-1,3-dimethoxypropane. Another examples of compounds comprised in formulae (III) include, but not limited to: 1,1-bis(methoxymethyl)-cyclopentadiene; 1,1-bis(methoxymethyl)-2,3,4,5-tetramethylcyclopentadiene; 1,1-bis(methoxymethyl)-2,3,4,5-tetraphenylcyclopentadiene; 1,1-bis(methoxymethyl)-2,3,4,5-tetrafluorocyclopentadiene; 1,1-bis(methoxymethyl)-3,4-dicyclopentylcyclopentadiene; 1,1-bis(methoxymethyl)indene; 1,1-bis(methoxymethyl)-2,3-dimethylindene; 1,1-bis(methoxymethyl)-4,5,6,7-tetrahydroindene; 1,1-bis(methoxymethyl)-2,3,6,7-tetrafluoroindene; 1,1-bis(methoxymethyl)-4,7-dimethylindene; 1,1-bis(methoxymethyl)-3,6-dimethylindene; 1,1-bis(methoxymethyl)-4-phenylindene; 1,1-bis(methoxymethyl)-4-phenyl-2-methylindene; 1,1-bis(methoxymethyl)-4-cyclohexylindene; 1,1-bis(methoxymethyl)-7-(3,3,3-trifluoropropyl)indene; 1,1-bis(methoxymethyl)-7-trimethyisilylindene; 1,1-bis(methoxymethyl)-7-trifluoromethylindene; 1,1-bis(methoxymethyl)-4,7-dimethyl-4,5,6,7-tetrahydroindene; 1,1-bis(methoxymethyl)-7-methylindene; 1,1-bis(methoxymethyl)-7-cyclopenthylindene; 1,1-bis(methoxymethyl)-7-isopropylindene; 1,1-bis(methoxymethyl)-7-cyclohexylindene; 1,1-bis(methoxymethyl)-7-tert-butylindene; 1,1-bis(methoxymethyl)-7-tert-butyl-2-methylindene; 1,1-bis(methoxymethyl)-7-phenylindene; 1,1-bis(methoxymethyl)-2-phenylindene; 1,1-bis(methoxymethyl)-1H-benz[e]indene; 1,1-bis(methoxymethyl)-1H-2-methylbenz[e]indene. Specific examples of compounds comprised in formulae (III) include, but not limited to; 9,9-bis(methoxymethyl)fluorene; 9,9-bis(methoxymethyl)-2,3,6,7-tetramethylfluorene; 9,9-bis(methoxymethyl)-2,3,4,5,6,7-hexafluorofluorene; 9,9-bis(methoxymethyl)-2,3-benzofluorene; 9,9-bis(methoxymethyl)-2,3,6,7-dibenzofluorene; 9,9-bis(methoxymethyl)-2,7-diisopropylfluorene; 9,9-bis(methoxymethyl)-1,8-dichlorofluorene; 9,9-bis(methoxymethyl)-2,7-dicyclopentylfluorene; 9,9-bis(methoxymethyl)-1,8-difluorofluorene; 9,9-bis(methoxymethyl)-1,2,3,4-tetrahydrofluorene; 9,9-bis(methoxymethyl)-1,2,3,4,5,6,7,8-octahydrofluorene; and 9,9-bis(methoxymethyl)-4-tert-butylfluorene.

In a preferred embodiment of the present invention, succinate compounds are charged in the amount of 5-30 mol % (with respect to total amount of internal electron donors), which is much lower than the range of 50-90% described by, for example, U.S. Pat. Nos. 9,068,028 and 9,0680,29. In a preferred embodiment of the present invention, succinate and 1,3-diether are charged in the molar ratio range of about 1:10-3:6, which is much lower than the range of 4:6-9.1 described by, for example, U.S. Pat. No. 10,221,261. In a preferred embodiment of the present invention, the molar ratio of 1,3-diether and succinate in the resulting catalyst composition (1,3-diether/succinate) is in the range of about 1.85-10.0, which is much higher than the range 0.8-1.8 described by U.S. Pat. No. 9,593,171.

According to embodiments of present invention, molar ratio of malonate and 1,3-diether is 0.5˜2.5, more preferably 0.8˜1.5 and molar ratio of malonate and succinate is 1.5˜10.0, more preferably 2.5˜7.5. Molar ratio of dialkylurea and magnesium (dialkylura/Mg) is 0.005˜0.1 and more preferably 0.01 to 0.05.

An acceptable catalyst system that may be used in accordance with the present invention comprises (a) a solid Ziegler-Natta type catalyst component, (b) a co-catalyst component, and optionally (c) one or more external electron donors.

A preferred solid Ziegler-Natta type catalyst component (a) include solid catalyst components comprising a titanium compound having at least a Ti-halogen bond, electron donors comprising dialkylurea, malonate, succinate, and 1,3-diether compounds supported on an anhydrous magnesium-dihalide support. Such preferred solid Ziegler-Natta type catalyst component (a) include solid catalyst components comprising a titanium halide. A preferred titanium halide is titanium tetrahalide, TiCl₄, further more titanium alkoxy halides may also be used for the formation of solid Ziegler-Natta type catalyst component (a). Acceptable anhydrous magnesium dihalides forming the support of the solid Ziegler-Natta type catalyst component (a) are the magnesium dihalides in active form that are well known in the art. Such magnesium dihalides may be pre-activated, may be activated in situ during the titanation, may be formed in-situ from a magnesium alkoxide compound, which is capable of forming magnesium dihalide when treated with a suitable halogen-containing transition metal compound, and then activated. Preferred magnesium dihalides are magnesium dichloride and magnesium dibromide. The water content of the dihalides is generally less than 1% by weight.

The solid Ziegler-Natta type catalyst component (a) may be made by various methods. One such method consists of co-grinding the magnesium dihalide, dialkylurea, malonate, succinate, and 1,3-diether, until the product shows a surface area higher than 20 m²/g and thereafter reacting the ground product with the Ti compound. Other methods of preparing solid Ziegler-Natta type catalyst component (a) are well known to person skilled in the art, such as methods disclosed in U.S. Pat. Nos. 4,220,554; 4,294,721; 4,315,835; 4,330,649; 4,439,540; 4,816,433; and 4,978,648, which are incorporated herein by reference in their entireties. In a typical modified solid Ziegler-Natta type catalyst component (a), the molar ratio between the magnesium compound and the halogenated titanium compound is between 1 and 500, the molar ratio between said magnesium compound and diakyl urea is between 0.1 and 50, and the molar ratio between said magnesium compound and succinate and dilakylurea is between 0.1 and 50.

Preferred co-catalyst component (b) includes aluminum alkyl compounds. Acceptable aluminum alkyl compounds include aluminum trialkyls, such as aluminum triethyl, aluminum triisobutyl, and aluminum triisopropyl. Other acceptable aluminum alkyl compounds include aluminum-dialkyl hydrides, such as aluminum-diethyl hydrides. Other acceptable co-catalyst component (b) includes compounds containing two or more aluminum atoms linked to each other through hetero-atoms, such as:

(C₂H₅)₂Al—O—Al(C₂H₅)₂

(C₂H₅)₂Al—N(C₆H₅)—Al(C₂H₅)₂; and

(C₂H₅)₂Al—O—SO₂—O—Al(C₂H₅)₂.

Acceptable external electron donor component (c) includes organic compounds containing O, Si, N, S, and/or P. Such compounds include organic acids, organic acid esters, organic acid anhydrides, ethers, ketones, alcohols, aldehydes, silanes, amides, amines, amine oxides, thiols, various phosphorus acid esters and amides, etc. Preferred component (c) is organosilicon compounds containing Si—O—C and/or Si—N—C bonds. Examples of such organosilicon compounds include, but are not limited to, trimethylmethoxysilane, diphenyldimethoxysilane, cyclohexylmethyldimethoxysilane, diisopropyldimethoxysilane, dicyclopentyldimethoxysilane, isobutyltriethoxysilane, vinyltrimethoxysilane, dicyclohexyldimethoxysilane, 3-tert-Butyl-2-isobutyl-2methoxy-[1,3,2]oxazasilolidine, 3-tert-Butyl-2-cyclopentyl-2-methoxy-[1,3,2]oxazasilolidine, 2-Bicyclo[2.2.1]hept-5-en-2-yl-3-tert-butyl-2-methoxy-[1,3,2]oxazasilolidine, 3-tert-Butyl-2,2-diethoxy-[1,3,2]oxazasilolidine, 4,9-Di-tert-butyl-1,6-dioxa-4,9-diaza-5-sila-spiro[4.4]nonane, and bis(perhydroisoquinolino)dimethoxysilane. Mixtures of organic electron donors may also be used.

The olefin polymerization processes that may be used in accordance with the present invention are not generally limited. For example, the catalyst components (a), (b) and (c), when employed, may be added to the polymerization reactor simultaneously or sequentially. It is preferred to mix components (b) and (c) first and then contact the resultant mixture with component (a) prior to the polymerization.

The olefin monomer may be added prior to, with, or after the addition of the Ziegler-Natta type catalyst system to the polymerization reactor. It is preferred to add the olefin monomer after the addition of the Ziegler-Natta type catalyst system.

The molecular weight of the polymers may be controlled in a known manner, preferably by using hydrogen. With the catalysts produced according to the present invention, molecular weight may be suitably controlled with hydrogen when the polymerization is carried out at relatively low temperatures, e.g., from about 30° C. to about 105° C. This control of molecular weight may be evidenced by a measurable positive change of the Melt Flow Rate.

The polymerization reactions may be carried out in slurry, liquid or gas phase processes, or in a combination of liquid and gas phase processes using separate reactors, all of which may be done either by batch or continuously. The polyolefin may be directly obtained from gas phase process, or obtained by isolation and recovery of solvent from the slurry process, according to conventionally known methods.

There are no particular restrictions on the polymerization conditions for production of polyolefins by the method of the present invention, such as the polymerization temperature, polymerization time, polymerization pressure, monomer concentration, etc. The polymerization temperature is generally from 40-90° C. and the polymerization pressure is generally 1 atmosphere or higher.

The Ziegler-Natta type catalyst systems of the present invention may be pre-contacted with small quantities of olefin monomer, well known in the art as pre-polymerization, in a hydrocarbon solvent at a temperature of 60° C. or lower for a time sufficient to produce a quantity of polymer from 0.5 to 3 times the weight of the catalyst. If such a pre-polymerization is done in liquid or gaseous monomer, the quantity of resultant polymer is generally up to 1000 times the catalyst weight.

The Ziegler-Natta type catalyst systems of the present invention are useful in the polymerization of olefins, including but not limited to homo-polymerization and copolymerization of alpha olefins. Suitable α-olefins that may be used in a polymerization process in accordance with the present invention include olefins of the general formula CH₂═CHR, where R is H or C₁₋₁₀ straight or branched alkyl, such as ethylene, propylene, butene-1, pentene-1, 4-methylpentene-1 and octene-1. While the Ziegler-Natta type catalyst systems of the present invention may be employed in processes in which ethylene is polymerized, it is more desirable to employ the Ziegler-Natta type catalyst systems of the present invention in processes in which propylene or higher olefins are polymerized. Processes involving the homo-polymerization or copolymerization of propylene are preferred.

In order to provide a better understanding of the foregoing, the following non-limiting examples are offered. Although the examples may be directed to specific embodiments, they are not to be viewed as limiting the invention in any specific respect. The activity values (AC) are based upon grams of polymer produced per gram of solid catalyst component used. The following analytical methods are used to characterize the polymer.

Heptane Insolubles (HI %): The weight percent (wt %) of residuals of polypropylene sample after extracted with boiling heptane for 8 hours.

Melt Flow Rate (MFR): ASTM D-1238, determined at 230° C. under the load of 2.16 kg.

### Example 1

### The Preparation of a Solid Catalyst Component (A-1)

A three neck 250 ml flask equipped with fritted filter disk and mechanical stirrer, which is thoroughly purged with nitrogen, was charged with 67 mmol of magnesium ethoxide and 60 ml of anhydrous toluene to form a suspension. To the suspension was added 2.5 mmol of tetramethylurea, 6.0 mmol of diethylphenylmalonate, 2.0 mmol of diethyl 2,3-diisopropylsuccinate and 5.0 mmol of 2-isopropyl 2-isopentyl dimethoxy propane and injected 20 ml of TiCl₄, followed by heating up to 110° C. with agitation at that temperature for 2 hours. The resulting solid was washed twice with 100 ml of anhydrous toluene at 90° C., and 60 ml of fresh anhydrous toluene and 20 ml of TiCl₄ were added thereto for reacting with agitation at 105° C. for one hour. After the completion of the reaction, the solid was washed with 100 ml toluene. Then, after adding 20 ml of TiCl₄ and agitation at 105° C. for one more hour, the resulting solid was washed with 100 ml toluene and 7 times with 100 ml of anhydrous n-heptane at 90° C. and was dried under a reduced pressure to obtain a solid composition (A-1). Catalyst composition analysis shows that it contains 5.1 wt % 1,3-diether, 3.3 wt % succinate, 2.0 wt % malonate with 2.1 wt % of Ti, and results are summarized in Table 2.

### The Preparation of a Solid Catalyst Component (A-2)

A three neck 250 ml flask equipped with fritted filter disk and mechanical stirrer, which is thoroughly purged with nitrogen, was charged with 67 mmol of magnesium ethoxide and 60 ml of anhydrous toluene to form a suspension. To the suspension was added 2.0 mmol of tetramethylurea, 7.0 mmol of diethylphenylmalonate, 1.0 mmol of diethyl 2,3-diisopropylsuccinate and 5.0 mmol of 2-isopropyl 2-isopentyl dimethoxy propane and injected 20 ml of TiCl₄. Then, followed by heating up to 110° C. with agitation at that temperature for 2 hours. The resulting solid was washed twice with 100 ml of anhydrous toluene at 90° C., and 60 ml of fresh anhydrous toluene and 20 ml of TiCl₄ were added thereto for reacting with agitation at 105° C. for one hour. After the completion of the reaction, the solid was washed with 100 ml toluene. Then, after adding 20 ml of TiCl₄ and agitation at 105° C. for one more hour, the resulting solid was washed with 100 ml toluene and 7 times with 100 ml of anhydrous n-heptane at 90° C. and was dried under a reduced pressure to obtain a solid composition (A-2). Catalyst composition analysis shows that it contains 5.3 wt % 1,3-diether, 1.6 wt % succinate, 2.8 wt % malonate with 2.1 wt % of Ti, and results are summarized in Table 2.

### The Preparation of a Solid Catalyst Component (C-1)

Catalyst prepared in the same way as catalyst component (A-2) except that diethylphenylmalonate was not charged to make catalyst component (C-1). Catalyst composition analysis shows that it contains 5.2 wt % 1,3-diether, 4.5 wt % succinate, 2.0 wt % malonate with 2.2 wt % of Ti, and results are summarized in Table 2.

### The Preparation of a Solid Catalyst Component (C-2)

Catalyst prepared in the same way as catalyst component (A-2) except that diethyl 2,3-diisopropylsuccinate was not charged to make catalyst component (C-2)

### The Preparation of a Solid Catalyst Component (C-3)

Catalyst prepared in the same way as catalyst component (A-3) except that tetramethylurea was not charged to make catalyst component (C-3)

### Propylene Bulk Phase Polymerization (B)

Propylene polymerization was conducted in a bench scale 2 liter reactor per the following procedure. The reactor was first preheated to at least 100° C. with a nitrogen purge to remove residual moisture and oxygen. The reactor was thereafter cooled to 50° C. Under nitrogen, 2.5 ml of triethylaluminum (0.6M, in hexanes), 0.25 mmol of diisopropyldimethoxysilane and 7 mg of solid catalyst component (A-1) prepared above were charged. After addition of hydrogen and 1.2 liter of liquefied propylene, temperature was raised to 70° C., to start polymerization. The polymerization was conducted for 1 hour at 70° C. The polymer was evaluated for melt flow rate (MFR), heptane insoluble (HI %). The activity of catalyst (AC) was also measured. The results are shown in TABLE 3.

TABLE 1
Internal donor charged (mmol)/7.5 g Mg(OEt)₂

| | |
|---|---|
| Catalyst A-1 | Malonate (6.0), Succinate (2.0), IIDMP(5.0), TMU (2.5) |
| Catalyst A-2 | Malonate (7.0), Succinate (1.0), IIDMP(5.0), TMU (2.0) |
| Catalyst C-1 | Succinate (3.0), IIDMP(5.0), TMU(2.0) |
| Catalyst C-2 | Malonate (7.0), IIIDMP(5.0), TMU(2.0) |
| Catalyst C-3 | Malonate (7.0), Succinate (1.0), IIDMP(5.0) |
| Catalyst C-4 | DiBP (8.0) |

Malonate = diethylphenylmalonate
Succinate = diethyl 2,3-diisopropylsuccinate
IIDMP = 2-isopropyl-2-isopentyl-dimethoxypropane
TMU = Tetramethylurea

TABLE 2
Catalyst Composition Analysis

| | | | | | 1,3- | ID/Ti |
|---|---|---|---|---|---|---|
| | | | | | diether/succinate | molar |
| Catalyst | Ti % | malonate | Succinate | 1,3-diether | molar ratio | ratio |
| A-1 | 2.1 wt % | 2.0 wt % | 3.3 wt % | 5.1 wt % | 1.85 | 1.0 |
| A-2 | 2.1 wt % | 2.8 wt % | 1.6 wt % | 5.3 wt % | 3.96 | 1.0 |

TABLE 3
Bulk polymerization results

| | | | MFR | | |
|---|---|---|---|---|---|
| Catalyst | H2(psi) | Yield | (g/10 min) | Mw/Mn | HI % |
| A-1 | 20 | 233.0 g | 9.6 | 5.6 | 99.2 |
| | 30 | 241.0 g | 17.7 | 5.1 | 99.1 |
| A-2 | 20 | 210.8 g | 16.2 | 4.9 | 98.8 |
| | 40 | 223.0 g | 38.5 | 4.7 | 98.8 |
| C-1 | 20 | 210.7 g | 15.7 | 5.3 | 98.4 |
| C-2 | 30 | 232.3 g | 19.1 | 4.4 | 98.9 |
| C-3 | 30 | 205.2 g | 23.5 | 4.6 | 98.9 |
| C-4 | 30 | 203.2 g | 11.0 | 5.1 | 98.3 |

As shown in Table 3, catalysts prepared according to embodiment of present invention (A-1, A-2) demonstrates high isotacticity (HI %) as well as broad Mw/Mn (4.9-5.6), whereas comparative catalysts, which was not prepared according to present invention, shows either narrow MWD or low isotacticity (HI %). That is, comparative catalyst (C-1) without malonate compound shows low isotacticity (HI %), comparative catalyst (C-2) without succinate compound shows narrow Mw/Mn, and comparative catalyst (C-3) without TMU shows narrow Mw/Mn. Comparative catalyst (C-4) employing phthalate electron donor shows lower isotacticity (HI %) than the catalysts (A-1, A-2) prepared according to present invention.

Also, as shown in the Table 2, molar ratio of 1,3-diether/succinate components of catalyst A-1 and A-2 of present invention in resulting catalyst composition are 1.85 and 3.96, respectively, which is much higher than range of 0.8-1.8 described in U.S. Pat. No. 9,593,171.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings therein. It is therefore evident that the particular embodiments disclosed above may be altered or modified and all such variations are considered within the scope and sprit of the present invention.

What is claimed is:

1. A solid catalyst component for the Ziegler-Natta polymerization or co-polymerization of alpha-olefins, comprising internal electron donors comprising a dialkylurea compound, a malonate compound, a succinate compound, and a 1,3-diether compounds;
wherein the succinate compound is less than 30% by mol with respect to total amount of internal electron donors;
wherein the molar ratio between the succinate compound and the 1,3-diether compound is in the range of about 0.1-0.5; and
wherein the molar ratio between the malonate compound and the 1,3-diether compound is in the range of about 0.3-2.5.

2. The solid catalyst component of claim 1, wherein the dialkylurea compound is selected from compounds represented by: 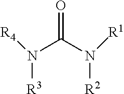
wherein R¹, R², R³, and R⁴ are independently selected from hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a hetero atom containing a hydrocarbon group of 1 to 20 carbon atoms; and wherein two or more of R¹, R², R³, and R⁴ may be linked to form one or more saturated or unsaturated monocyclic or polycyclic rings.

3. The solid catalyst component of claim 1, wherein the malonate compound is an ester of malonic acid.

4. The solid catalyst component of claim 1, wherein the succinate compound is selected from compounds represented by: 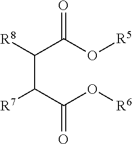
wherein R⁵, R⁶, R⁷, and R⁸ are independently selected from hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a hetero atom containing hydrocarbon group of 1 to 20 carbon atoms.

5. The solid catalyst component of claim 1, wherein the 1,3 diether compound is selected from compounds represented by: 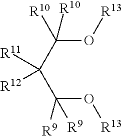
wherein R⁹, R¹⁰, R¹¹, R¹² and R¹³ are independently selected from a hydrocarbon group having 1 to 20 carbon atoms or an aromatic hydrocarbon group having 6-20 carbon atoms; wherein two or more of R⁹, R¹⁰, R¹¹, R¹² and R¹³ can form one or more saturated or unsaturated monocyclic or polycyclic rings.
